(19) United States
(12) Patent Application Publication
(10) Pub. No.: US 2006/0219745 A1
(43) Pub. Date: Oct. 5, 2006

(54) Carry-on luggage with beverage container holder

(76) Inventor: Kathleen Seale Riley, Anchorage, AK (US)

Correspondence Address: DEAN A. CRAINE, SUITE 140, 400 - 112TH AVENUE NE, BELLEVUE, WA, 98004, US

(21) Appl. No.: 11/099,969

(22) Filed: Apr. 5, 2005

(51) Int. Cl. B60R 9/00; B62J 11/00

(52) U.S. Cl. 224/400; 224/463

(57) ABSTRACT

A carry-on luggage with a beverage holder designed to conveniently hold a beverage container without spilling as the user travels through an airport terminal. The holder includes a rigid support member suspended from the upper cross-member on the luggage's telescoping handle. The support member is held in a suspended position by two length adjustable arms attached to the handle's cross-member. The support member includes a laterally extending blocking bar that contacts at least one support arm on the handle which prevents the support member from sliding under the cross arm. The two arms extend downward from the cross member and pivotally connect to two posts located on opposite sides of the cup support member to allow the cup support member to maintain horizontal alignment at all times. When the handle on the carrier is extended, the beverage accessory holder is raised and automatically opens to a horizontal position so that a beverage container may be placed in the beverage holder.

### BACKGROUND OF THE INVENTION

1. Field of the Invention

The invention disclosed herein relates to carry-on luggage, and more particularly to carry-on luggage with wheels and a telescopic handle.

2. Description of the Related Art

Carry-on luggage used by airline passengers is designed to fit into the overhead storage compartments located above the seats in the aircraft. Such luggage typically includes a pair of wheels located on the lower edge of the luggage bag and a longitudinally aligned, telescoping handle that extends upward from the top end of the luggage bag that allows the luggage to be easily pulled behind the passenger and he or she walks through the terminal.

Due to increase security measures now adopted at most large airports, airline passengers are now required to show their personal identification and boarding pass at several security check points located inside the terminal and at the loading gate. Most passengers temporarily carry these in their hands or have their personal identification conveniently located in a pocket or sleeve until they are seated in the aircraft. Due to the long wait times at airports, many airline travelers like to drink beverages when traveling through airports. Unfortunately, it is very difficult to carry a beverage container in one hand, pull a piece of carry-on luggage in the other hand, and handle or retrieve personal identification and a boarding pass in the other. If a passenger is drinking a beverage and is asked for personal identification and a boarding pass, the passenger must first place the luggage bag in an upright position, and then use an available hand or surface for temporarily holding the beverage container. Because handling these items is so difficult, many passengers elect to forgo drinking beverages in airports.

What is needed is a piece of carry-on luggage with wheels and a telescopic handle with a beverage container holder attached thereto that conveniently holds a beverage container when the carry-on luggage is placed in an upright or diagonally aligned position.

### SUMMARY OF THE INVENTION

It is an object of the present invention to provide a piece of carry-on luggage with a beverage container holder.

It is another object of the present invention to provide such luggage that safely holds a beverage container when the luggage is being pulled behind a passenger and when the luggage is disposed in an upright position or diagonal position.

It is another object of the present invention to provide such luggage that allows the beverage container to be easily removed from the luggage or stored in a non-obstructing, compact configuration on the luggage body when the handle is retracted.

These and other objects of the invention are met by a piece of carry-on luggage with a beverage holder designed to attach to the luggage's upper handle. The holder includes a planar cup support member suspended between two support arms that hang downward from the handle's upper cross member. Located inside the cup support member is at least one-cup holder opening designed to receive a standard paper cup, plastic cup or bottle. In two embodiments shown herein, the two support arms rotatably engage the handle's cross-member so that they may swing freely around the cross-member.

The two support arms are arranged on the cross-member so that the cup support member is centrally located under the handle's cross member. Formed on or attached to the front edge of the cup support member is a laterally extending blocking bar. The blocking bar is sufficient in length to extend laterally from the front edge of the cup support member and contact one of the handle's support legs. The blocking bar prevents the cup support member from swinging freely under the handle's cross member. The opposite ends of the two support arms are pivotally connected to two laterally extending posts located along the center axis and on the opposite sides of the cup support member. Because the two support arms members are pivotally attached to the opposite sides of the cup support member, the cup support member is able to freely rotate and automatically horizontally aligns itself below the handle's cross member when the luggage body is either vertically or diagonally aligned.

When the handle is raised to an extended position, the two support arm members are rotated around the handle's cross member and hang downward therefrom so that the cup support member is positioned on the rear side of the handle. When a beverage container is placed into a container opening the cup support member automatically aligns itself in a horizontal position. When the handle is retracted into the luggage body, the two support arms are rotated over the handle's cross member and extended over the top surface of the luggage body. Hook and loop connectors may be used to hold the cup support member in place over the top surface of the luggage body. The cup support member is rotated over the distal ends of the two support straps and folded into flat configuration over the top surface. Alternately, the cup support member may be disengaged from the two support arms and stored in an outer pocket on the luggage body.

An optional flexible bag may be attached to the cup support member to create a document pocket on the cup support member.

### DESCRIPTION OF THE DRAWINGS

FIG. 1 is a perspective view of a piece of carry-on luggage shown in a vertical upright position with a longitudinally aligned retractable handle with a beverage holder attached to the handle.

FIG. 2 is a perspective view of the beverage container holder designed to hold two beverage containers.

FIG. 3 is a perspective view of the beverage holder shown in FIG. 2 with an optional bag attached to the lower edge of the cup holder support member.

FIG. 4 is a perspective view of an alternative embodiment of the beverage holder with one beverage cup holder and a document pocket.

FIG. 5 is a left side elevational view of the invention shown in FIG. 1.

FIG. 6 is a side elevational view of the carry-on luggage being pulled in a diagonal position.

FIG. 7 is a left side elevational view of the carry-luggage in a vertical position with the handle stowed in a retracted position and the beverage container placed over the top end surface.

FIG. 8 is a left side elevational view of the carry-on luggage being pulled that uses a second embodiment of the beverage container holder.

FIG. 9 is a left side elevational view of the carry-on luggage shown in FIG. 8 aligned in an upright vertical position.

FIG. 10 is a left side elevational view of the carry-on luggage shown in FIGS. 8 and 9 shown in a vertical position with the handle stowed in a retracted position and the beverage container placed over the top end surface.

FIG. 11 is a top plan view of the carry-on luggage shown in FIG. 9.

FIG. 12 is a front elevational view of the carry-on luggage shown in FIG. 9.

FIG. 13 is a top plan view of the carry-on luggage showing the cup support member in a stored position on the top surface of the luggage bag.

FIG. 14 is a side elevational view of the rigid adjustable support arm.

### DESCRIPTION OF THE PREFERRED EMBODIMENT(S)

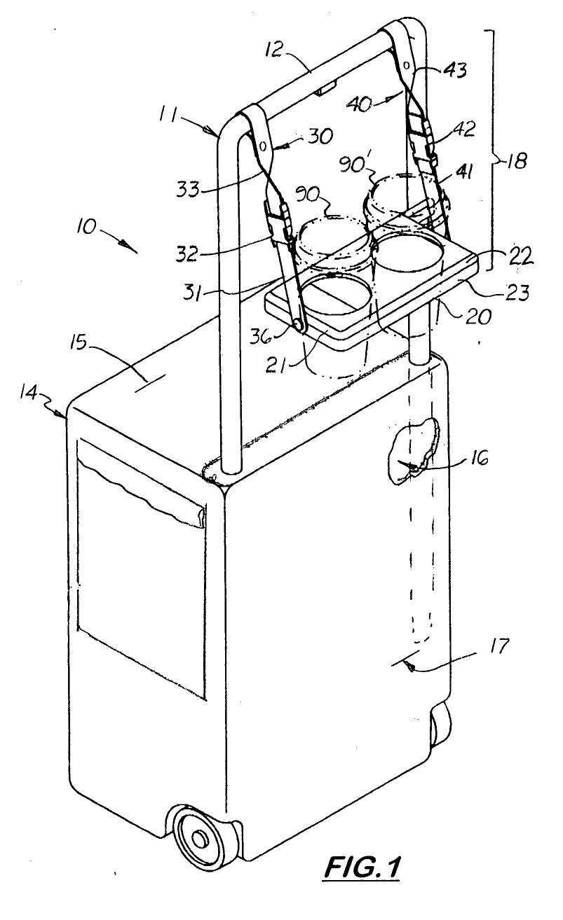

Referring to the accompanying Figs there is shown a piece of carry-on luggage 10 with a beverage holder 18 designed to conveniently hold at least one beverage container 90 while the luggage 10 is placed in an upright, vertically aligned position as shown in FIG. 1 and when placed in a diagonally aligned position when being pulled behind a user as shown in FIG. 6. The beverage holder 18 includes a rigid cup support member 20 suspended between two straps 30, 40 that hang downward from the handle's upper cross member 12. The two straps 30, 40 are able to rotate freely around the cross member 12 and the cup support member 20 is able to rotate freely over the ends of the two strap members 30, 40 thereby keeping a beverage container 90 placed into the cup support member 20 in an upright position at all times while the luggage 10 is pulled through the airport terminal.

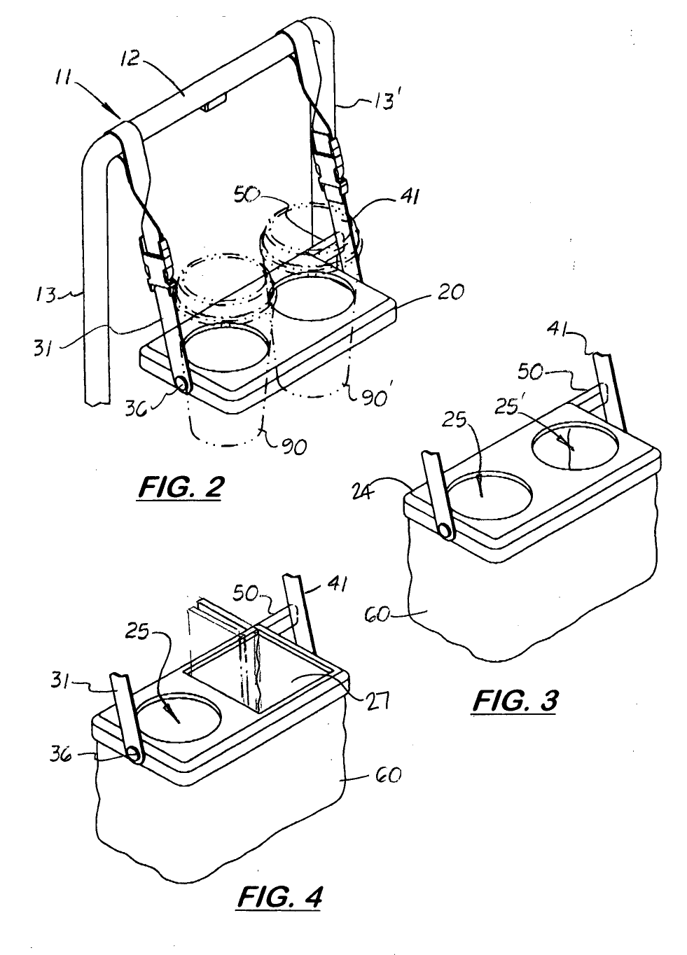

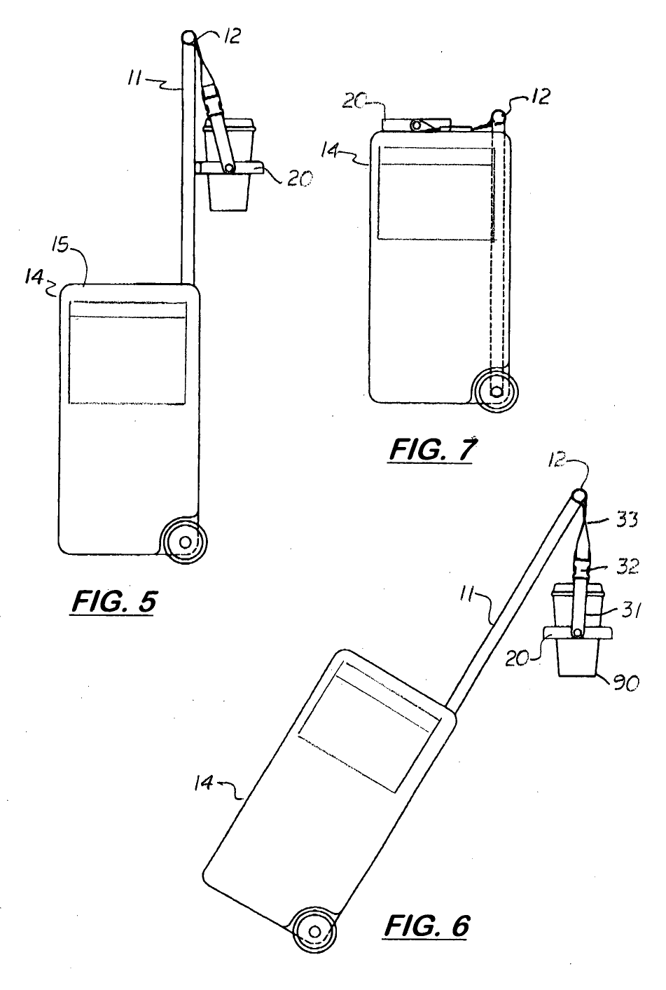

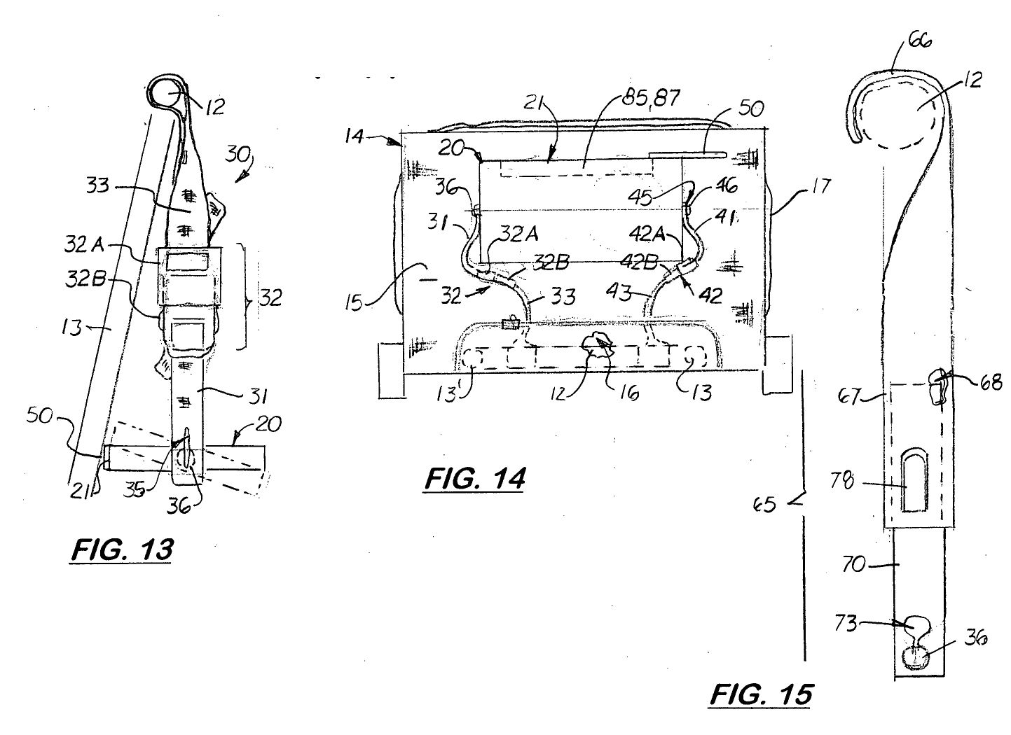

The carry-on luggage 10 includes a telescopic handle 11 that extends upward from the top surface 15 of the luggage body 14. The handle 11 may extend from a handle pocket 16 formed on the top surface 15 of the luggage body 14 or extend from the back surface 17 of the luggage body 14. The cup support member 20 is a planar structure with at least one beverage container opening 25 formed therein. In the first embodiment shown in the FIGS. 1-7, the cup support member 20 includes two, centrally aligned container holder openings 25, 25′ designed to receive two standard size paper or plastic beverage containers 90, 90′. In the first embodiment, the two arms 30, 40 each include a lower flexible strap member 31, 41, a combination male-female buckle connector 32B, 42B, (see FIGS. 13 & 14) and an upper strap member, 33, 43, respectively. The upper strap members 33, 43 wrap around the upper cross-member 12 and connect to the female buckle connector 32B, 42B, respectively, and allow the upper strap members 33, 43 to be adjusted in length. The upper ends of the upper strap members 33, 43 are attached to the front surfaces to the middle portion of each strap with a pair of snap connectors or a pair of hook and loop connectors. The upper end of each lower strap member 31, 41 is connected to a male buckle connector 32A, 42B, respectively, while the opposite lower ends pivotally connects to the opposite side walls 21, 22 of the support member 20. Two short posts 36, 46 extend laterally from the opposite side walls of the support member 20 which engage two slots 35, 45 (shown in FIGS. 13 & 14) formed near the distal ends of the lower strap members 31, 41, respectively.

Formed or separately attached to the front surface 23 of the support member 20 is a laterally extending blocking bar 50. The length of the blocking bar 50 is sufficient so that it extends laterally from the adjacent sidewall 21 of the support member 20 to contact one of the support arms 13 or 13′ on the handle 11 thereby preventing the cup support member 20 from swinging under the cross-member 12. When the luggage 10 is vertically aligned as shown in FIG. 1, the blocking bar 50 contacts the rear surface of the support arm 13′ maintains the cup support member 20 in an off-set position with respect to the luggage body 14 so that spilled liquid drips onto the floor and not onto the top surface 15 of the luggage body 14.

As stated above, the handle 11 on the carry-on luggage 10 telescopically contracts or slides into a handle pocket 16 formed on the luggage body 14 (see FIG. 14). Because the two arm 30, 40 are attached to the cross-member 12, the two arm 30, 40 are rotated and folded over the top surface 15 of the luggage body 14 when the handle 11 is retracted into the pocket 16. Also, when the handle 11 is retracted, the cup support member 20 may be rotated into a flush position or the top surface 15 or removed from the two strap members 30, 40 and placed inside an outer pocket 17 formed on the luggage body 14. Loop and hook connectors 85, 87 may be used to hold the cup support member 20 on the top surface 14. When the cup support member 20 is removed from the two arms 30, 40 the two arms 30, 40 may be tucked inside the pocket 16 and under the cross member 12.

In the preferred embodiment, the cup support member 20 is made of plastic and measures approximately 7 inches in length, 3 inches in width, and ¾ inch thick. FIG. 3 shows an optional bag structure 60 attached to the perimeter edges of the cup support member 20 and positioned under the two beverage openings 25, 25′. FIG. 4 shows an alterative support member 20′ with a bag structure 60 attached thereto with one circular cup holder opening 25 and one square or rectangular-shaped opening 27. The square or rectangular shaped opening 27 may be used to temporarily hold personal identification or boarding passes which are repeatedly shown when traveling through the airport terminal.

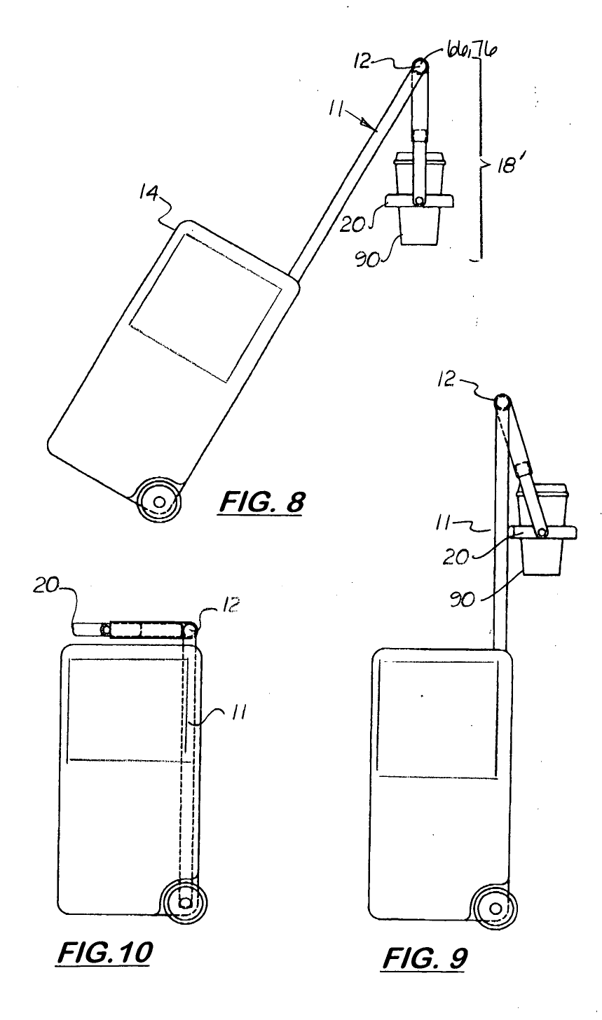

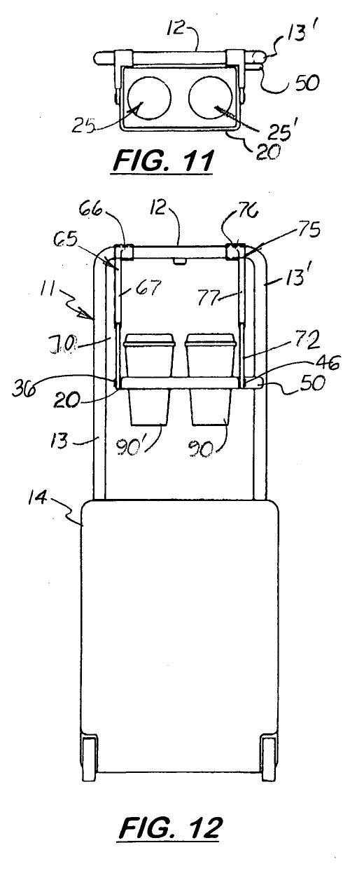

FIGS. 8-12 shows an alternative holder 18′ that uses two rigid arms 65, 75 with cylindrical-shaped members 66, 76, respectfully, designed to snap fit onto the handle's cross member 12. As shown in FIG. 15 attached to each cylindrical-shape member 66, 76 is a rigid perpendicularly aligned upper segment 67, 77. Formed inside each upper segment 67, 77 is a longitudinally aligned receiving cavity 68, 69 designed to receive a rigid lower segment 70, 72, respectfully. A locking member 77 is disposed between the distal end of the upper segment 67 and the lower segment 70. Each lower arm 70, 72 include a slot 73, 74, respectfully, that are designed to receive the post 36 or 46 on the sides of the support member 20. The second beverage holder 18′ operates in the same manner as the first beverage holder 18 to constantly maintain the beverage container 90 placed into the beverage opening 25 in a horizontal position when the luggage 10 is upright or when aligned in a diagonal position when being pulled behind a user.

In both embodiments, the length of the two pairs of arms 30, 40 and 65, 75 is sufficient so that the top edges or lid of a beverage container 90 does not contact the handle's cross-member 12 as the luggage is being used. The length of the arms 30, 40, 65, and 75 must also be sufficient so that the user's foot or leg does not kick or contact the bottom edge of the beverage container 90 as the user walks and pulls the luggage behind.

In the preferred embodiment, the straps 30, 40, 65 and 75 are adjusted in length so that the cup support members 20, 20′ are positioned approximately 12 inches below the cross member 12 and approximately 12 inches above the top surface 15 of the luggage body 14 when the luggage 10 is vertically aligned.

In compliance with the statute, the invention described herein has been described in language more or less specific as to structural features. It should be understood, however, that the invention is not limited to the specific features shown, since the means and construction shown is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A beverage container holder for a piece of carry-on luggage, comprising:
a. a luggage body with a retractable, longitudinally aligned handle, said handle capable of being selectively moved between an longitudinally extended position on one end of said luggage body to a retracted position on said luggage body, said handle including two support legs and a transversely aligned cross-member, at least two wheels attached to said luggage body that enables said luggage body to be pulled in a diagonally aligned position behind a user; and,
b. a beverage container holder attached to said cross-member, said beverage container including two arms and a cup support member, said arms being rotatably attached to said cross-member and pivotally attached at their opposite ends to said cup support member, said cup support member including at least one container opening capable of receiving a beverage container, and a front edge, said cup support member also including means for preventing said cup support member from swinging under said cross support member with said luggage body is vertically aligned.

2. The beverage container holder as recited in claim 1, wherein each said arm is adjusted in length.

3. The beverage container holder, as recited in claim 1, wherein each said arm is made of flexible material.

4. The beverage container holder, as recited in claim 1, wherein each said arm includes an upper strap member, a lower strap member and a male-female connector used to selectively connect said upper strap member and said lower strap member together.

5. The beverage container holder as recited in claim 1, wherein each said arm is made of rigid material that snap fits around said cross-member of said handle.

6. The beverage container holder, as recited in claim 5, wherein each said arm is made of plastic.

7. The beverage container holder, as recited in claim 4, wherein each said arm includes an upper leg member and a lower leg member that slides longitudinally into said upper leg to adjust the overall length of said support strap.

8. The beverage container holder, as recited in claim 1, further including a bag attached to and extending under said cup support member.

9. The beverage container holder, as recited in claim 8, wherein said cup support member includes a document opening.

10. The beverage container holder, as recited in claim 1, wherein said means for preventing the cup support member from swinging under said cross-member is a laterally extending bar attached to said front edge of said cup support member.

11. The beverage container holder, as recited in claim 3, wherein said means for preventing the cup support member from swinging under said cross-member is a laterally extending bar attached to said front edge of said cup support member.

12. A beverage container holder for a piece of carry-on luggage that includes a retractable, longitudinally aligned handle, said handle capable of being selectively moved between an longitudinally extended position on one end of said luggage body to a retracted position on said luggage body, said handle including two support legs and a transversely aligned cross-member, at least two wheels attached to said luggage body that enables said luggage body to be pulled in a diagonally aligned position behind a user; said beverage holder including:
a. two arms that extend downward from said cross-member;
b. a cup support member, said cross-member being rotatably attached to said arms, said cup support member including at least one container opening capable of receiving a beverage container, and a front edge, said cup support member also including means for preventing said cup support member from swinging under said cross support member with said luggage body is vertically aligned.

13. The beverage container holder, as recited in claim 12, wherein said means for preventing the cup support member from swinging under said cross-member is a laterally extending bar attached to said front edge of said cup support member.

14. The beverage container holder, as recited in claim 13, wherein said cup support member includes a document opening.
